(19) United States
(12) Patent Application Publication
(10) Pub. No.: US 2024/0086812 A1
(43) Pub. Date: Mar. 14, 2024

(54) A METHOD, AN APPARATUS AND A NON-TRANSITORY COMPUTER READABLE MEDIUM FOR MEASURING PRODUCTIVITY

(71) Applicant: NEC Corporation, Minato-ku, Tokyo (JP)

(72) Inventors: Isaac PEK, Singapore (SG); Masaharu MORIMOTO, Singapore (SG); Hayato CHISHAKI, Tokyo (JP)

(73) Assignee: NEC Corporation, Minato-ku, Tokyo (JP)

(21) Appl. No.: 18/271,163

(22) PCT Filed: Aug. 8, 2022
(86) PCT No.: PCT/JP2022/030283

§ 371 Date: Jul. 6, 2023

(30) Foreign Application Priority Data
Aug. 19, 2021 (SG) 10202109093T

(51) Int. Cl. G06Q 10/0633; G06T 7/20

(52) U.S. Cl. CPC G06Q 10/0633; G06T 7/20

(57) ABSTRACT

A method, an apparatus (70) and a program(s) for measuring productivity are provided. The method comprises: identifying a first movement based on at least one image frame, wherein the first movement matches a start action which define a cycle of movements (S1); identifying a second movement based on at least one image frame, wherein the second movement matches an end action which define the cycle (S2); and determining a period of time between the identified first movement and the identified second movement to measure productivity (S3).

### TECHNICAL FIELD

The present invention relates broadly, but not exclusively, to a method, an apparatus(es) and a program(s) for measuring productivity.

### BACKGROUND ART

For manufacturers, cycle time is an important indicator to measure the productivity in their assembly lines.

One cycle at each workbench typically consists of a series of actions such as, mounting components on the board, tightening a screw or putting the cover for packaging, etc.

### CITATION LIST

### Patent Literature

PTL 1: International Patent Publication No. WO2018/191555A1

### SUMMARY OF INVENTION

### Technical Problem

Traditionally, cycle time is manually measured by line managers using a stop-watch. Since the measurement is done by sampling in such cases, it is difficult to get statistics based on long-term and continuous monitoring results.

Video analytics can help to estimate the cycle time instead of solely relying on manual effort. Behavior analytics especially, has the potential to detect the series of actions related to the work process in assembly lines.

This disclosure is related to cycle time estimation methods, a cycle time estimation apparatus and a cycle time estimation program(s) using hand position for factory assembly lines, but its application can be expanded to cover other scenarios, for example, food preparation in kitchens.

Herein disclosed are example embodiments of a device(s) and methods and a program(s) for measuring productivity that addresses one or more of the above problems.

Furthermore, other desirable features and characteristics will become apparent from the subsequent detailed description and the appended claims, taken in conjunction with the accompanying drawings and this background of the disclosure.

### Solution to Problem

According to a first aspect, a method for measuring productivity executed by a computer is provided, the method comprises:
identifying a first movement based on at least one image frame, wherein the first movement matches a start action which define a cycle of movements;
identifying a second movement based on at least one image frame, wherein the second movement matches an end action which define the cycle; and
determining a period of time between the identified first movement and the identified second movement to measure productivity.

According to a second aspect, an apparatus for measuring productivity is provided, the apparatus comprises:
at least one processor; and
at least one memory including computer program code; wherein
the at least one memory and the computer program code are configured to, with at least one processor, cause the apparatus to:
identify a first movement based on at least one image frame, wherein the first movement matches a start action which define a cycle of movements;
identify a second movement based on at least one image frame, wherein the second movement matches an end action which define the cycle; and
determine a period of time between the identified first movement and the identified second movement to measure productivity.

According to a third aspect, a non-transitory computer readable medium storing a program for measuring productivity is provides, the program causes a computer at least to:
identify a first movement based on at least one image frame, wherein the first movement matches a start action which define a cycle of movements;
identify a second movement based on at least one image frame, wherein the second movement matches an end action which define the cycle; and
determine a period of time between the identified first movement and the identified second movement to measure productivity.

### BRIEF DESCRIPTION OF DRAWINGS

The accompanying FIGS. 1 to 8, where like reference numerals refer to identical or functionally similar elements throughout the separate views and which together with the detailed description below are incorporated in and form part of the specification, serve to illustrate various example embodiments and to explain various principles and advantages in accordance with a present example embodiment, by way of non-limiting example only.

Example embodiments will be better understood and readily apparent to one of ordinary skill in the art from the following written description, by way of example only, and in conjunction with the drawings, in which:

FIG. 1 shows a system for measuring productivity according to an aspect of the present disclosure.

FIG. 2 shows a method of measuring productivity according to an example embodiment.

FIG. 3 shows how imputation is performed to fill in the gaps for missing movements.

FIG. 4 depicts how various ground truths are received according to an example embodiment.

FIG. 5 depicts how a ground truth may be obtained from averaging various ground truths that were received.

FIG. 6 shows main components of the method of measuring productivity.

FIG. 7 shows main components of an apparatus of measuring productivity according to an example embodiment.

FIG. 8 shows an exemplary computing device that may be used to execute the method of measuring productivity.

### DESCRIPTION OF EMBODIMENTS

Terms Description

Subject—a subject may be any suitable type of entity, which may include a person, a worker and a user.

The term target or target subject is used herein to identify a person, a user or worker that is of interest. The target subject may be one that is selected by a user input or one who is identified to be of interest.

A subject or an identified subject is used herein to relate to a person who is related to the target subject (e.g. partner or someone with similar skillset). For example, in the context of measuring productivity, the subject is someone who may be considered to have the similar skillset or experience as the target.

A user who is registered to a productivity measuring server will be called a registered user. A user who is not registered to the productivity measuring server will be called a non-registered user. It is possible for the user to obtain productivity measurement of any subject.

Productivity measuring server—The productivity measuring server is a server that hosts software application programs for receiving inputs, processing data and objectively providing graphical representation. The productivity measuring server communicates with any other servers (e.g., a remote assistance server) to manage requests. The productivity measuring server communicates with a remote assistance server to receive ground truths or predetermined movements. Productivity measuring servers may use a variety of different protocols and procedures in order to manage the data and provide a graphical representation.

The productivity measuring server is usually managed by a provider that may be an entity (e.g. a company or organization) which operates to process requests, manage data and receive/display graphical representations that are useful to a situation. The server may include one or more computing devices that are used for processing graphical representation requests and providing customizable services depending on situations.

A productivity measuring account—a productivity measuring account is an account of a user who is registered at a productivity measuring server. In certain circumstances, the productivity measuring account is not required to use the remote assistance server. A productivity measuring account includes details (e.g., name, address, vehicle etc.) of a user. An indicator of productivity is cycle time which is a period of time between identified pairs of first movement and second movement.

The productivity measuring manages productivity measuring accounts of users and the interactions between users and other external servers, along with the data that is exchanged.

### DETAILED DESCRIPTION

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that above relating to prior art arrangements relate to discussions of devices which form public knowledge through their use. Such should not be interpreted as a representation by the present inventor(s) or the patent applicant that such devices in any way form part of the common general knowledge in the art.

The System 100

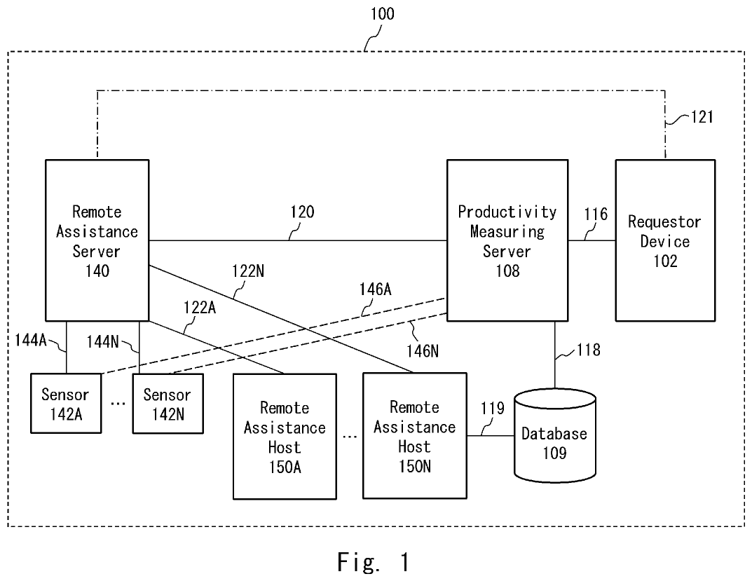

FIG. 1 illustrates a block diagram of a system 100 for measuring productivity for a target. The system 100 comprises a requestor device 102, a productivity measuring server 108, a remote assistance server 140, remote assistance hosts 150A to 150N, and sensors 142A to 142N.

The requestor device 102 is in communication with a productivity measuring server 108 and/or a remote assistance server 140 via a connection 116 and 121, respectively. The connection 116 and 121 may be wireless (e.g., via NFC communication, Bluetooth™, etc.) or over a network (e.g., the Internet). The connection 116 and 121 may also be that of a network (e.g., the Internet).

The productivity measuring server 108 is further in communication with the remote assistance server 140 via a connection 120. The connection 120 may be over a network (e.g., a local area network, a wide area network, the Internet, etc.). In one arrangement, the productivity measuring server 108 and the remote assistance server 140 are combined and the connection 120 may be an interconnected bus. The productivity measuring server 108 can access to a database 109 via connection 118. The database 109 can store a variety of data processed by the productivity measuring server 108.

The remote assistance server 140, in turn, is in communication with the remote assistance hosts 150A to 150N via respective connections 122A to 122N. The connections 122A to 122N may be a network (e.g., the Internet).

The remote assistance hosts 150A to 150N are servers. The term host is used herein to differentiate between the remote assistance hosts 150A to 150N and the remote assistance server 140. The remote assistance hosts 150A to 150N are collectively referred to herein as the remote assistance hosts 150, while the remote assistance host 150 refers to one of the remote assistance hosts 150. The remote assistance hosts 150 may be combined with the remote assistance server 140.

In an example, the remote assistance host 150 may be one managed by a factory and the remote assistance server 140 is a central server that manages productivity at an organization level and decides which of the remote assistance hosts 150 to forward data or retrieve data like image inputs. The remote assistance hosts 150 can access to the database 109 via connection 119. The database 109 can store a variety of data processed by the remote assistance hosts 150.

Sensors 142A to 142N are connected to the remote assistance server 140 or the productivity measuring server 108 via respective connections 144A to 144N or 146A to 146N. The sensors 142A to 142N are collectively referred to herein as the sensors 146A to 146N. The connections 144A to 144N are collectively referred to herein as the connections 144, while the connection 144 refers to one of the connections 144. Similarly, the connections 146A to 146N are collectively referred to herein as the connections 146, while the connection 146 refers to one of the connections 146. The connections 144 and 146 may be wireless (e.g., via NFC communication, Bluetooth, etc.) or over a network (e.g., the Internet). The sensor 142 may be one of an image capturing device, video capturing device, and motion sensor and may be configured to send an input depending its type, to at least one of the productivity measuring server 108.

In the illustrative example embodiment, each of the devices 102 and 142; and the servers 108, 140, and 150 provides an interface to enable communication with other connected devices 102 and 142 and/or servers 108, 140, and 150. Such communication is facilitated by an application programming interface (“API”). Such APIs may be part of a user interface that may include graphical user interfaces (GUIs), Web-based interfaces, programmatic interfaces such as application programming interfaces (APIs) and/or sets of remote procedure calls (RPCs) corresponding to interface elements, messaging interfaces in which the interface elements correspond to messages of a communication protocol, and/or suitable combinations thereof.

Use of the term ‘server’ herein can mean a single computing device or a plurality of interconnected computing devices which operate together to perform a particular function. That is, the server may be contained within a single hardware unit or be distributed among several or many different hardware units.

The Remote Assistance Server 140

The remote assistance server 140 is associated with an entity (e.g. a factory or a company or organization or moderator of the service). In one arrangement, the remote assistance server 140 is owned and operated by the entity operating the server 108. In such an arrangement, the remote assistance server 140 may be implemented as a part (e.g., a computer program module, a computing device, etc.) of server 108.

The remote assistance server 140 may also be configured to manage the registration of users. A registered user has a contact tracing account (see the discussion above) which includes details of the user. The registration step is called on-boarding. A user may use either the requestor device 102 to perform onboarding to the remote assistance server 140.

It is not necessary to have a productivity measuring account at the remote assistance server 140 to access the functionalities of the remote assistance server 140. However, there are functions that are available to a registered user. For example, it may be possible to display graphical representation of target subjects and potential subjects in other jurisdictions. These additional functions will be discussed below.

The on-boarding process for a user is performed by the user through one of the requestor device 102. In one arrangement, the user downloads an app (which includes the API to interact with the remote assistance server 140) to the sensor 142. In another arrangement, the user accesses a website (which includes the API to interact with the remote assistance server 140) on the requestor device 102.

Details of the registration include, for example, name of the user, address of the user, emergency contact, or other important information and the sensor 142 that is authorized to update the remote assistance account, and the like.

Once on-boarded, the user would have a contact tracing account that stores all the details.

The Requestor Device 102

The requestor device 102 is associated with a subject (or requestor) who is a party to a contact tracing request that starts at the requestor device 102. The requestor may be a concerned member of the public who is assisting to get data necessary to obtain a graphical representation of a network graph. The requestor device 102 may be a computing device such as a desktop computer, an interactive voice response (IVR) system, a smartphone, a laptop computer, a personal digital assistant computer (PDA), a mobile computer, a tablet computer, and the like.

In one example arrangement, the requestor device 102 is a computing device in a watch or similar wearable and is fitted with a wireless communications interface.

The Productivity Measuring Server 108

The productivity measuring server 108 is as described above in the terms description section.

The productivity measuring server 108 is configured to process processes relating to determining a period of time between the identified first movement and the identified second movement to measure productivity.

The Remote Assistance Hosts 150

The remote assistance host 150 is a server associated with an entity (e.g. a company or organization) which manages (e.g. establishes, administers) productivity information regarding information relating to a subject or a member of an organization.

In one arrangement, the entity is an organization. Therefore, each entity operates a remote assistance host 150 to manage the resources by that entity. In one arrangement, a remote assistance host 150 receives an alert signal that a target subject is in motion. The remote access host 150 may then arrange to send resources to the location identified by the location information included in the alert signal. For example, the host may be one that is configured to obtain relevant video or image input for processing.

Advantageously, such information is valuable to detect accurate start and end timings for cycle time estimation at factory assembly lines. This disclosure uses correlations between hand positions and start/end timings of cycles. As such, a more accurate estimated cycle timing can be obtained.

Hand positions are better suited to identify start/end timings of cycles in factory situation because objects move from left to right or vice versa on belt conveyers at assembly lines. Thus, the actual position can generate better features for those situations.

However, the time-series of actual positions would be different conventional technique which utilizes distance instead of position, resulting in pattern matching (given a query sequence, find similar sequences in a target dataset) generating more false matches. Also, hand detection may detect hand positions incorrectly, again, contributing to a higher number of false matches.

Therefore, to make pattern matching more accurate, the present disclosure identifies which hands are already detected, and subsequently imputes (replacing missing positions with substituted values) missing data that are due to missed detections or occlusions. Alternatively or additionally, the present disclosure collects sequences corresponding to a ground truth on a sample dataset. For a ground truth, the start actions and end actions that constitute a work cycle are pre-defined.

For example, the user may define the start and end actions (each action comprising a consecutive sequence of hand movements, or predetermined movements) of a work cycle by providing the timestamp that these actions occur on a video clip obtained from the camera of interest. In an example embodiment, two sets of predetermined movements are defined to cover the start and the end of a cycle.

At the same time, the number of expected hands within the camera view is also specified. This value is directly related to the number of workers/operators expected to be visibly working in the camera view (for example, if there are two operators, four hands can be expected and if there is one operator, two hands can be expected.

Alternatively or additionally, the present disclosure generates averaged query sequences from the collected sequences so that the query sequences can be used as input queries to look for similar sequences that represent start and end timings in target datasets.

Sensor 142

The sensor 142 is associated with a user associated with the requestor device 102. More details of how the sensor may be utilized will be provided below.

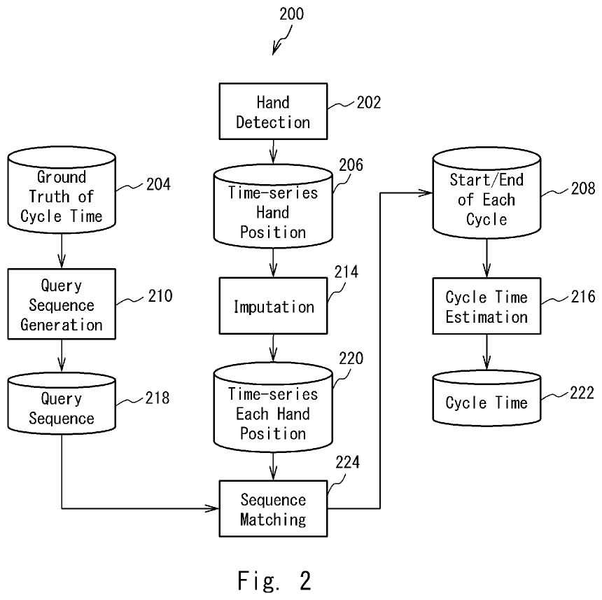

FIG. 2 shows a method 200 of measuring productivity according to an example embodiment of the present disclosure. As shown in 202, hand detection is performed to detect hands on given image frames and generates time-series hand positions with the corresponding frame number in 206.

By taking the detected hand positions in the first process 202, imputation 214 is performed. Specifically, the method includes detecting the number of hands in frame and comparing the detected number of hands with expected number of hands in the frame to detect the missing hands in the frame. If the missing hands in the frame is detected, imputation 214 is performed for imputation of the missing hands in the frame to generate timeseries hand positions as shown in 220 with hand identifies (which may identify the target) and the corresponding frame numbers.

For example, imputation will look at the expected number of hands in the camera view (specified in the ground truth), and compare it with the number of hand detections for each video frame. For example, if it expects four hands, but there are only three hands for a given frame, imputation is performed to fill in the absent data, i.e. at least one absent position of the missing hand in a missing period of the missing hand, making the data ‘complete’ by looking at the average historical position of a hand corresponding to the missing hand.

Sequence matching 224 checks which of the second output, i.e. the timeseries hand positions 220, matches the given query sequences in 218 to detect start and end timings, then outputs the matched sequences 208 with the frame numbers.

On the third output, cycle time estimation 216 estimates each cycle of the assembly line and outputs the estimated cycle times as shown in 222. In various example embodiments, cycle time is a period of time between identified pairs of first movement and second movement. The first movement corresponds to a start of the cycle. On the other hand, the second movement corresponds to an end of the cycle.

To provide a query sequence that is the input of the third process 224, query sequence generation 210 generates queries 218 to detect start and end timings on given input data based on given ground truth (or predetermined movements) of start and end timings specified on sample datasets 204. The query sequence based on given ground truth of start timings corresponds to a first sequence of positions of a hand(s) which is the start action in a work of a worker(s) or an operation of an operator(s). On the other hand, the query sequence based on given ground truth of end timings corresponds to a second sequence of positions of a hand(s) which is the end action in the work or the operation.

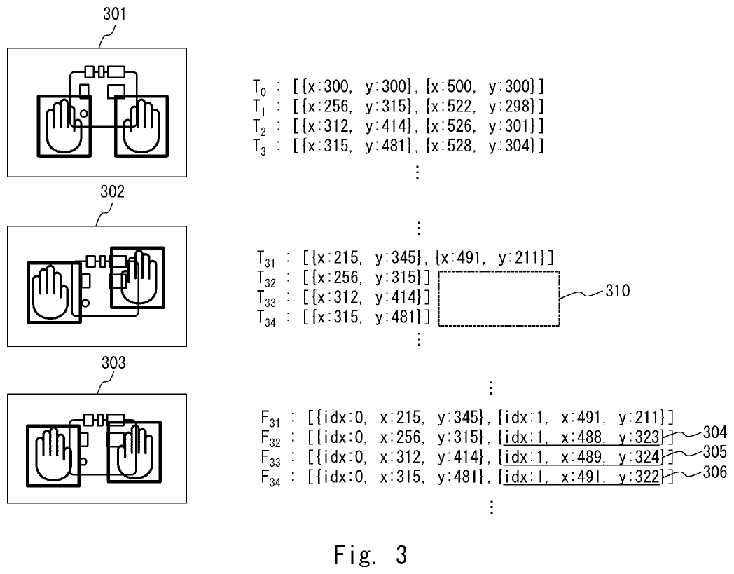

FIG. 3 shows how to use predetermined movements in averaging ground truths. The start actions and end actions that constitute a work cycle are pre-defined.

In various example embodiments, the user will define the start and end actions of a work cycle by providing the timestamp that these actions occur on a video clip obtained from the camera of interest. Each action comprises a consecutive sequence of hand movements, or predetermined movements. Two sets of predetermined movements are defined to cover the start and the end of a cycle.

In an example embodiment, the number of expected hands within the camera view is also specified. This value is directly related to the number of workers or operators expected to be visibly working in the camera view. For example, if there are two operators, four hands can be expected. If there is one operator, two hands can be expected.

For each video frame, imputation will look at the expected number of hands in the camera view (specified in the ground truth), and compare it with the number of hand detections for each video frame. For example, if it expects 4 hands, but there are only 3 hands for a given frame, imputation is performed to fill in the absent data, i.e. at least one absent position of the missing hand in a missing period of the missing hand, making the data ‘complete’ by looking at the average historical position of a hand corresponding to the missing hand.

Each of 301 and 302 shows a possible predetermined movement or a set of ground truths. In 303, certain movements may be detected and there may be missing hand movements 310. As shown by 304, 305 and 306, imputation may be carried out to fill in the gaps (e.g. idx:1, x:488, y:323, idx:1, x:489, y:324, idx:1, x:491, y:322) where there would otherwise be missing data. Missing data will adversely affect time-series sequence matching due to an increase in false matches.

The output of averaging ground truth is a pair of averaged predetermined movements that is representative of the actions, as such, it is coupled with a known technique called Dynamic Time Warping to match for similar first movement(s) and second movement(s) amongst a plurality of movements (detected hand positions that have been converted to time series data) that are obtained from the same camera view. This may be one that is obtained after the detected hand position data has been ‘pre-treated’ by imputation.

This coupling allows variations in the sequence of movements that constitute a start or end action of a work cycle. For example. a first averaged predetermined movement may consist of an upward movement, followed immediately by a downward movement, but a real-world first movement may consist of an upward movement, a rightward movement, followed by a downward movement. In this case, the real-world first movement would still match with the first averaged predetermined movement, despite the obvious difference. Similarly, if a movement was omitted, a match may still be possible.

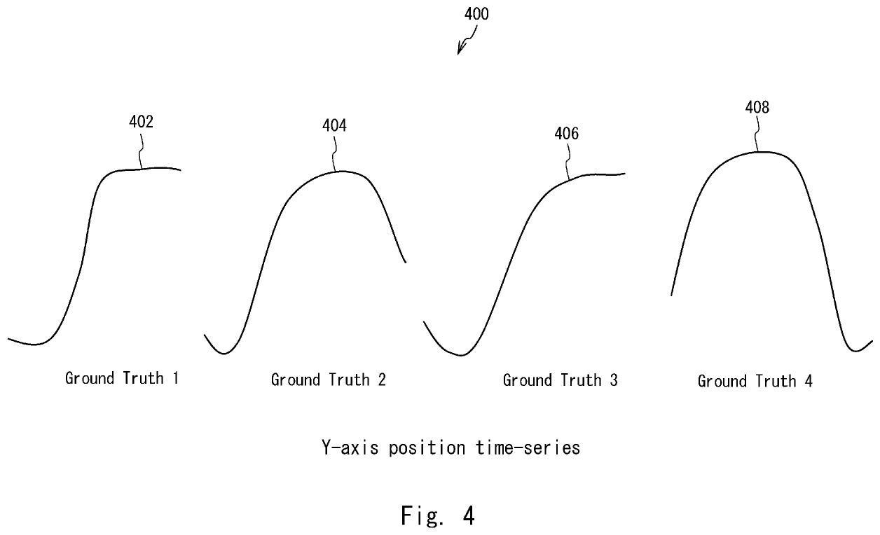

FIG. 4 depicts how various ground truths are received according to an example embodiment of the present disclosure. In FIG. 4, each time-series pattern 402, 404, 406,408 and 410 shown in 400 is obtained from a user-defined ground truth or predetermined movement, and are examples of sequences corresponding to the start of a cycle. For the purposes of measuring productivity of a target, time-series patterns relating to subjects having similar experiences are retrieved.

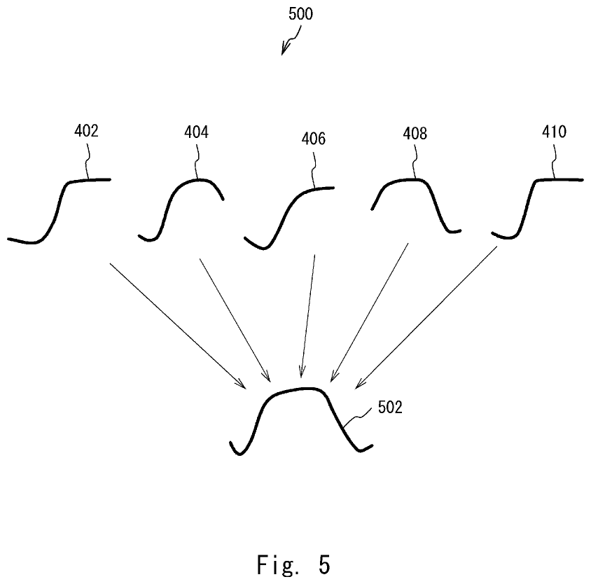

FIG. 5 depicts how a ground truth 502 may be obtained from averaging various ground truths that were received 500. An averaging of sequences 402, 404, 406 and 408 is performed to obtain a final query sequence that is used as input to sequence matching in order to identify similar sequences within a target dataset.

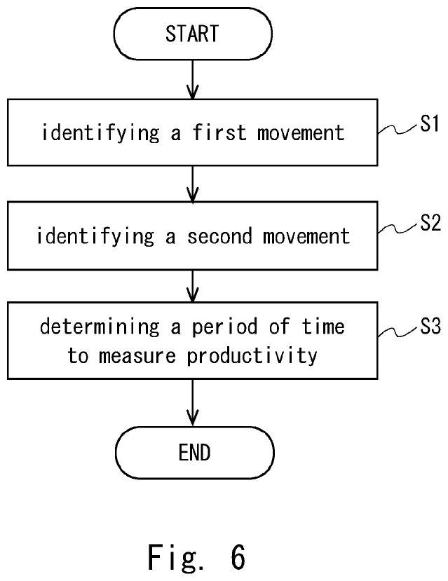

FIG. 6 shows main components of the method of measuring productivity. According to various example embodiments, there is method of measuring productivity. This method comprises: identifying a first movement based on at least one image frame, wherein the first movement matches a start action which define a cycle of movements (S1); identifying a second movement based on at least one image frame, wherein the second movement matches an end action which define the cycle (S2); and determining a period of time between the identified first movement and the identified second movement to measure productivity (S3).

The method further comprises: detecting the number of hands in the image frame; comparing the detected number of hands with an expected number of hands in the frame to detect at least one missing hand in the frame; and performing an imputation of a movement of the missing hand in the frame in response of detecting the missing hand in the frame. Therefore, the movement of the missing hand can be compensated even though a hand is not captured in the frame. As a result, the first movement and/or the second movement can be identified in that case.

Further, the imputation is performed by using an average historical position of a hand corresponding to the missing hand in a missing period of the missing hand to fill an absent position of the missing hand.

Further, the method comprises: generating a first sequence of positions of hands corresponding to the start action; and generating a second sequence of positions of hands corresponding to the end action; wherein the identifying of the first movement includes identifying the first movement that matches the first sequence; and the identifying of the second movement includes identifying the second movement that matches the second sequence.

Further, the generating of the first sequence may include averaging a plurality of sequences of positions of the hands corresponding to start actions of the cycle of the movements to generate the first sequence. The generating of the second sequence may include averaging a plurality of sequences of positions of the hands corresponding to end actions of the cycle of the movements to generate the second sequence.

In the method according to the above, the identifying the first movement includes identifying if the first movement is performed by a right hand or a left hand.

Further, when it is identified that the first movement is performed by the right hand, the identifying the second movement may be performed. In this case, the right hand may be a dominant hand of a worker/operator.

Alternatively, when it is identified that the first movement is performed by the left hand, the identifying the second movement may be performed. In this case, the left hand may be the dominant hand of the worker/operator.

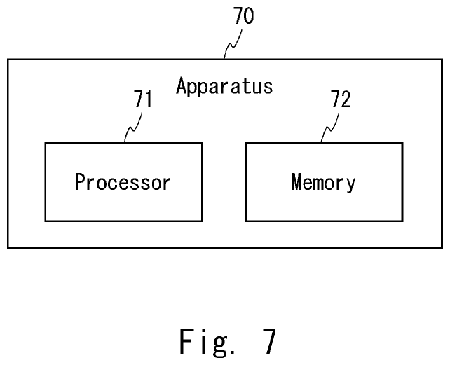

FIG. 7 shows main components of an apparatus of measuring productivity according to an example embodiment. The apparatus 70 includes at least one processor 71 and at least one memory 72 including computer program code. The at least one memory 72 and the computer program code are configured to, with at least one processor 71, cause the apparatus to execute the above-described method.

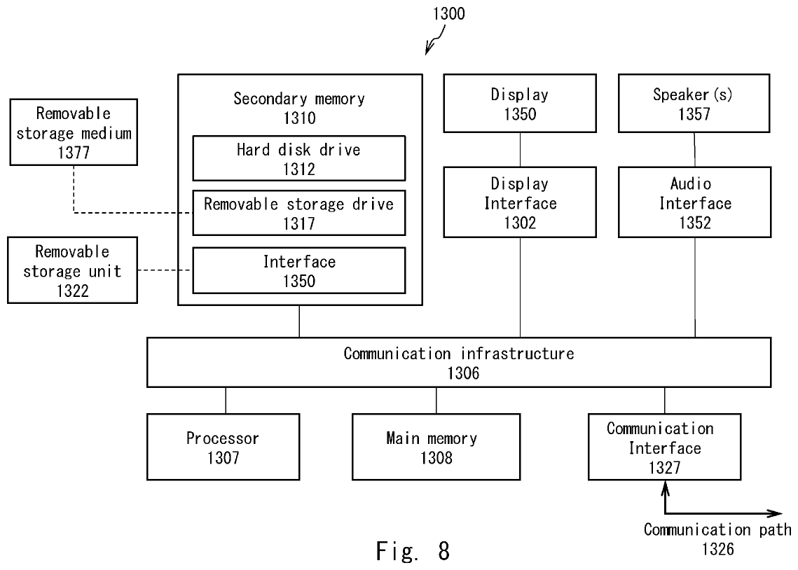

FIG. 8 depicts an exemplary computing device 1300, hereinafter interchangeably referred to as a computer system 1300, where one or more such computing devices 1300 may be used to execute the methods shown above. The exemplary computing device 1300 can be used to implement the system 100 shown in FIG. 1. The following description of the computing device 1300 is provided by way of example only and is not intended to be limiting.

As shown in FIG. 8, the example computing device 1300 includes a processor 1307 for executing software routines. Although a single processor is shown for the sake of clarity, the computing device 1300 may also include a multi-processor system. The processor 1307 is connected to a communication infrastructure 1306 for communication with other components of the computing device 1300. The communication infrastructure 1306 may include, for example, a communications bus, cross-bar, or network.

The computing device 1300 further includes a main memory 1308, such as a random access memory (RAM), and a secondary memory 1310. The secondary memory 1310 may include, for example, a storage drive 1312, which may be a hard disk drive, a solid state drive or a hybrid drive and/or a removable storage drive 1317, which may include a magnetic tape drive, an optical disk drive, a solid state storage drive (such as a USB flash drive, a flash memory device, a solid state drive or a memory card), or the like. The removable storage drive 1317 reads from and/or writes to a removable storage medium 1377 in a well-known manner. The removable storage medium 1377 may include magnetic tape, optical disk, nonvolatile memory storage medium, or the like, which is read by and written to by removable storage drive 1317. As will be appreciated by persons skilled in the relevant art(s), the removable storage medium 1377 includes a computer readable storage medium having stored therein computer executable program code instructions and/or data.

In an alternative implementation, the secondary memory 1310 may additionally or alternatively include other similar means for allowing computer programs or other instructions to be loaded into the computing device 1300. Such means can include, for example, a removable storage unit 1322 and an interface 1314. Examples of a removable storage unit 1322 and interface 1314 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 1322 and interfaces 1314 which allow software and data to be transferred from the removable storage unit 1322 to the computer system 1300.

The computing device 1300 also includes at least one communication interface 1327. The communication interface 1327 allows software and data to be transferred between computing device 1300 and external devices via a communication path 1326. In various example embodiments, the communication interface 1327 permits data to be transferred between the computing device 1300 and a data communication network, such as a public data or private data communication network. The communication interface 1327 may be used to exchange data between different computing devices 1300 which such computing devices 1300 form part an interconnected computer network. Examples of a communication interface 1327 can include a modem, a network interface (such as an Ethernet card), a communication port (such as a serial, parallel, printer, GPIB, IEEE 1394, RJ45, USB), an antenna with associated circuitry and the like. The communication interface 1327 may be wired or may be wireless. Software and data transferred via the communication interface 1327 are in the form of signals which can be electronic, electromagnetic, optical or other signals capable of being received by communication interface 1327. These signals are provided to the communication interface via the communication path 1326.

As shown in FIG. 8, the computing device 1300 further includes a display interface 1302 which performs operations for rendering images to an associated display 1350 and an audio interface 1352 for performing operations for playing audio content via associated speaker(s) 1357.

As used herein, the term “computer program product” may refer, in part, to removable storage medium 1377, removable storage unit 1322, a hard disk installed in storage drive 1312, or a carrier wave carrying software over communication path 1326 (wireless link or cable) to communication interface 1327. Computer readable storage media refers to any non-transitory, non-volatile tangible storage medium that provides recorded instructions and/or data to the computing device 1300 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 1300. Examples of transitory or nontangible computer readable transmission media that may also participate in the provision of software, application programs, instructions and/or data to the computing device 1300 include radio or infra-red transmission channels as well as a network connection to another computer or networked device, and the Internet or Intranets including e-mail transmissions and information recorded on Websites and the like.

The computer programs (also called computer program code) are stored in main memory 1308 and/or secondary memory 1310. Computer programs can also be received via the communication interface 1327. Such computer programs, when executed, enable the computing device 1300 to perform one or more features of example embodiments discussed herein. In various example embodiments, the computer programs, when executed, enable the processor 1307 to perform features of the above-described example embodiments. Accordingly, such computer programs represent controllers of the computer system 1300.

Software may be stored in a computer program product and loaded into the computing device 1300 using the removable storage drive 1317, the storage drive 1312, or the interface 1314. The computer program product may be a non-transitory computer readable medium. Alternatively, the computer program product may be downloaded to the computer system 1300 over the communication path 1326. The software, when executed by the processor 1307, causes the computing device 1300 to perform the necessary operations to execute the method as described above.

It is to be understood that the example embodiment of FIG. 8 is presented merely by way of example to explain the operation and structure of the system 100. Therefore, in some example embodiments one or more features of the computing device 1300 may be omitted. Also, in some example embodiments, one or more features of the computing device 1300 may be combined together. Additionally, in some example embodiments, one or more features of the computing device 1300 may be split into one or more component parts.

It will be appreciated by a person skilled in the art that numerous variations and/or modifications may be made to the present invention as shown in the specific example embodiments without departing from the spirit or scope of the invention as broadly described. The present example embodiments are, therefore, to be considered in all respects to be illustrative and not restrictive.

This application is based upon and claims the benefit of priority from Singaporean patent application No. 10202109093T, filed on Aug. 19, 2021, the disclosure of which is incorporated herein in its entirety by reference.

Supplementary Note

The whole or part of the example embodiments disclosed above can be described as, but not limited to, the following supplementary notes.

(Supplementary Note 1)

A method for measuring productivity executed by a computer, comprising:
identifying a first movement based on at least one image frame, wherein the first movement matches a start action which define a cycle of movements;
identifying a second movement based on at least one image frame, wherein the second movement matches an end action which define the cycle; and
determining a period of time between the identified first movement and the identified second movement to measure productivity.

(Supplementary Note 2)

The method according to supplementary note 1, further comprising:
detecting the number of hands in the image frame;
comparing the detected number of hands with an expected number of hands in the frame to detect at least one missing hand in the frame; and
performing an imputation of a movement of the missing hand in the frame in response of detecting the missing hand in the frame.

(Supplementary Note 3)

The method according to supplementary note 2, wherein the imputation is performed by using an average historical position of a hand corresponding to the missing hand in a missing period of the missing hand to fill an absent position of the missing hand.

(Supplementary Note 4)

The method according to supplementary note 1, further comprising:
generating a first sequence of positions of hands corresponding to the start action; and
generating a second sequence of positions of hands corresponding to the end action; wherein
the identifying of the first movement includes identifying the first movement that matches the first sequence; and
the identifying of the second movement includes identifying the second movement that matches the second sequence.

(Supplementary Note 5)

The method according to supplementary note 4, wherein
the generating of the first sequence includes averaging a plurality of sequences of positions of the hands corresponding to start actions of the cycle of the movements to generate the first sequence; and
the generating of the second sequence includes averaging a plurality of sequences of positions of the hands corresponding to end actions of the cycle of the movements to generate the second sequence.

(Supplementary Note 6)

An apparatus for measuring productivity, the apparatus comprising:
at least one processor; and
at least one memory including computer program code; wherein
the at least one memory and the computer program code are configured to, with at least one processor, cause the apparatus to:
identify a first movement based on at least one image frame, wherein the first movement matches a start action which define a cycle of movements;
identify a second movement based on at least one image frame, wherein the second movement matches an end action which define the cycle; and
determine a period of time between the identified first movement and the identified second movement to measure productivity.

(Supplementary Note 7)

The apparatus according to supplementary note 6, wherein the at least one memory and the computer program code configured to, with at least one processor, cause the apparatus to:
detect the number of hands in the image frame;
compare the detected number of hands with an expected number of hands in the frame to detect at least one missing hand in the frame; and
perform an imputation of a movement of the missing hand in the frame in response of detecting the missing hand in the frame.

(Supplementary Note 8)

The apparatus according to supplementary note 7, wherein the imputation is performed by using an average historical position of a hand corresponding to the missing hand in a missing period of the missing hand to fill an absent position of the missing hand.

(Supplementary Note 9)

The apparatus according to supplementary note 6, wherein the at least one memory and the computer program code configured to, with at least one processor, cause the apparatus to:
generate a first sequence of positions of hands corresponding to the start action;
generate a second sequence of positions of hands corresponding to the end action;
identify the first movement that matches the first sequence; and
identify the second movement that matches the second sequence.

(Supplementary Note 10)

The apparatus according to supplementary note 6 or 9, wherein the at least one memory and the computer program code configured to, with at least one processor, cause the apparatus to:
average a plurality of sequences of positions of the hands corresponding to start actions of the cycle of the movements to generate the first sequence; and
average a plurality of sequences of positions of the hands corresponding to end actions of the cycle of the movements to generate the second sequence.

(Supplementary Note 11)

A non-transitory computer readable medium storing a program for measuring productivity, wherein the program causes a computer at least to:
identify a first movement based on at least one image frame, wherein the first movement matches a start action which define a cycle of movements;
identify a second movement based on at least one image frame, wherein the second movement matches an end action which define the cycle; and
determine a period of time between the identified first movement and the identified second movement to measure productivity.

### REFERENCE SIGNS LIST

70 Apparatus
71 Processor
72 Memory
100 System
102 Requestor Device
108 Productivity Measuring Server
109 Database
140 Remote Assistance Server
142A˜142N Sensor
150A˜150N Remote Assistance Host

What is claimed is:

1. A method for measuring productivity executed by a computer, comprising:
identifying a first movement based on at least one image frame, wherein the first movement matches a start action which define a cycle of movements;
identifying a second movement based on at least one image frame, wherein the second movement matches an end action which define the cycle; and
determining a period of time between the identified first movement and the identified second movement to measure productivity.

2. The method according to claim 1, further comprising:
detecting the number of hands in the image frame;
comparing the detected number of hands with an expected number of hands in the frame to detect at least one missing hand in the frame; and
performing an imputation of a movement of the missing hand in the frame in response of detecting the missing hand in the frame.

3. The method according to claim 2, wherein the imputation is performed by using an average historical position of a hand corresponding to the missing hand in a missing period of the missing hand to fill an absent position of the missing hand.

4. The method according to claim 1, further comprising:
generating a first sequence of positions of hands corresponding to the start action; and
generating a second sequence of positions of hands corresponding to the end action; wherein
the identifying of the first movement includes identifying the first movement that matches the first sequence; and
the identifying of the second movement includes identifying the second movement that matches the second sequence.

5. The method according to claim 4, wherein:
the generating of the first sequence includes averaging a plurality of sequences of positions of the hands corresponding to start actions of the cycle of the movements to generate the first sequence; and
the generating of the second sequence includes averaging a plurality of sequences of positions of the hands corresponding to end actions of the cycle of the movements to generate the second sequence.

6. An apparatus for measuring productivity, the apparatus comprising:
at least one processor; and
at least one memory including computer program code; wherein
the at least one memory and the computer program code are configured to, with at least one processor, cause the apparatus to:
identify a first movement based on at least one image frame, wherein the first movement matches a start action which define a cycle of movements;
identify a second movement based on at least one image frame, wherein the second movement matches an end action which define the cycle; and
determine a period of time between the identified first movement and the identified second movement to measure productivity.

7. The apparatus according to claim 6, wherein the at least one memory and the computer program code configured to, with at least one processor, cause the apparatus to:
detect the number of hands in the image frame;
compare the detected number of hands with an expected number of hands in the frame to detect at least one missing hand in the frame; and
perform an imputation of a movement of the missing hand in the frame in response of detecting the missing hand in the frame.

8. The apparatus according to claim 7, wherein the imputation is performed by using an average historical position of a hand corresponding to the missing hand in a missing period of the missing hand to fill an absent position of the missing hand.

9. The apparatus according to claim 6, wherein the at least one memory and the computer program code configured to, with at least one processor, cause the apparatus to:
generate a first sequence of positions of hands corresponding to the start action;
generate a second sequence of positions of hands corresponding to the end action;
identify the first movement that matches the first sequence; and
identify the second movement that matches the second sequence.

10. The apparatus according to claim 9, wherein the at least one memory and the computer program code configured to, with at least one processor, cause the apparatus to:
average a plurality of sequences of positions of the hands corresponding to start actions of the cycle of the movements to generate the first sequence; and
average a plurality of sequences of positions of the hands corresponding to end actions of the cycle of the movements to generate the second sequence.

11. A non-transitory computer readable medium storing a program for measuring productivity, wherein the program causes a computer at least to:
identify a first movement based on at least one image frame, wherein the first movement matches a start action which define a cycle of movements;
identify a second movement based on at least one image frame, wherein the second movement matches an end action which define the cycle; and
determine a period of time between the identified first movement and the identified second movement to measure productivity.

12. The non-transitory computer readable medium according to claim 11, wherein the program causes the computer to:
detect the number of hands in the image frame;
compare the detected number of hands with an expected number of hands in the frame to detect at least one missing hand in the frame; and
perform an imputation of a movement of the missing hand in the frame in response of detecting the missing hand in the frame.

13. The non-transitory computer readable medium according to claim 12, wherein the imputation is performed by using an average historical position of a hand corresponding to the missing hand in a missing period of the missing hand to fill an absent position of the missing hand.

14. The non-transitory computer readable medium according to claim 11, wherein the program causes the computer to:
generate a first sequence of positions of hands corresponding to the start action; and
generate a second sequence of positions of hands corresponding to the end action; wherein
the identifying of the first movement includes identifying the first movement that matches the first sequence; and
the identifying of the second movement includes identifying the second movement that matches the second sequence.

15. The non-transitory computer readable medium according to claim 14, wherein:
the generating of the first sequence includes averaging a plurality of sequences of positions of the hands corresponding to start actions of the cycle of the movements to generate the first sequence; and
the generating of the second sequence includes averaging a plurality of sequences of positions of the hands corresponding to end actions of the cycle of the movements to generate the second sequence.
